(19) United States
(12) Patent Application Publication
(10) Pub. No.: US 2015/0183314 A1
(43) Pub. Date: Jul. 2, 2015

(54) MOVING VEHICLE EXHAUST COLLECTION SYSTEM

(71) Applicant: Create Technologies, Inc., Carson City, NV (US)

(72) Inventor: Nicholas P. De Luca, Carmel-by-the-Sea, CA (US)

(73) Assignee: CREATE TECHNOLOGIES, INC., Carson City, NV (US)

(21) Appl. No.: 14/145,891

(22) Filed: Dec. 31, 2013

(51) Int. Cl. B60K 13/04; F01N 13/00

(52) U.S. Cl. CPC B60K 13/04; F01N 13/002

(57) ABSTRACT

A robotic exhaust system to connect to a vehicle, a system to collect exhaust gas from a moving vehicle, and a method thereof is described. The robotic exhaust system includes: flexible tubing configured to connect to a tail pipe at a first end and to connect to an exhaust collection tubing interface at a second end; a motor configured to move the flexible tubing; a sensor configured to detect a marker in the road, wherein the marker provides information indicating a position of the exhaust collection tubing interface; and a controller configured to move the second end of the flexible tubing to the position of the exhaust collection tubing interface.

### BACKGROUND

Reducing vehicle emissions has been a strong focus for the federal government as catalytic converters were introduced in the early 1970's to insure cleaner exhaust. Levels as high as 20% of global warming gasses are attributed to vehicle emissions according to the United States Environmental Agency (US EPA) and smog in cities is strongly attributed to motor vehicle exhaust. In 2013, a study at the Massachusetts Institute of Technology by *Barret et al. indicated that in the US alone, approximately 50,000 deaths a year can be attributed to exhaust emissions from motor vehicles. A study published by the World Health Organization by Blanco showed that California children living near roadways had an increased risk of cancer due to diesel exhaust fumes. Despite the almost ten time reduction in exhaust pollutant from vehicles (according to the US EPA) from 1967 to 2002 due to tougher emission standards and technology improvements, the number of cars on the roads has increased by approximately the same factor. The elimination of exhaust gases from motor vehicle combustion engines would be a tremendous societal benefit.

Generally, motor vehicle exhaust from the combustion of gasoline contains water, carbon monoxide, nitrogen oxides, volatile organic compounds, hydrocarbons, airborne particles, sulfur dioxide, and carbon dioxide. These chemicals in combination with atmospheric constituent molecules, heat, moisture, and other chemicals including ammonia, combine to form noxious gasses including ozone, aldehydes, peroxyacyl nitrates, and nitrogen oxides.

According to the US Department of Transportation, “A typical automobile on the road in 2002 had an average trip length of 4.0 miles, and, with slightly more than 7 trips per day, an average of about 29 vehicle miles traveled per day. On a given weekday, cold starts of a typical vehicle produces 7.7 grams of Volatile Organic Compound (VOC) gases (25 percent of the typical daily emissions), 88 grams of Carbon-monoxide (CO) (26 percent of the typical daily emissions), and 5 grams of Nitrous Oxide (NOx) (19 percent of the typical daily emissions). Running exhaust accounts for another 7.8 grams of VOC, 251 grams of CO, and 20.2 grams of NOx.”

The U.S. Environmental Protection Agency estimates the average passenger car emissions in the United States for July 2000 is provided in Table 1 below.

TABLE 1

| Component | Emission Rate | Annual Pollution Emitted | |
|---|---|---|---|
| Hydrocarbons | 2.80 grams/mile (1.75 g/Km) | 7.1 | pounds (35.0 kg) |
| Carbon | 20.9 grams/mile (13.06 g/Km) | 75 | pounds (261 kg) |
| Monoxide | | | |
| NOx | 1.39 grams/mile (0.87 g/Km) | 8.2 | pounds (17.3 kg) |
| Carbon | 0.16 pounds per mile | 1,450 | pounds (5,190 kg) |
| Dioxide | (258 g/km) | | |

Extrapolating the above annual figures, these components add up to roughly 500 million vehicles on the road worldwide, and that yields values for total production of exhaust per year as noted in Table 2 below.

TABLE 2

| | Estimated Annual Pollution Emitted By |
|---|---|
| Component | Vehicles (B = Billion) |
| Hydrocarbons | 1.6 B pounds (0.72 B kg) |
| Carbon Monoxide | 37.5 B pounds (17.0 B kg) |
| NOx | 1.1 B pounds (0.5 B kg) |
| Carbon Dioxide | 725 B pounds (329.5 B kg) |

*Barrett, Fabio; Ashok, Akshay; Waitz, Ian A.; Yim, Steve H. L.; Barrett, Steven R.H. (November 2013). “Air pollution and early deaths in the United States. Part I: Quantifying the impact of major sectors in 2005”. Atmospheric Environment (Elsevier). Volume 79: 198-208. Bibcode:2013AtmEn . . . 79 . . . 198C. doi:10.1016/j.atmosenv.2013.05.081. Retrieved 25 Oct. 2013.

Collecting exhaust from vehicles is generally a very difficult task. Catalytic converters are effective at combining unburned hydrocarbons and carbon monoxide to produce carbon dioxide (CO2) and water. Diesel exhaust fluid is effective to help contain the exhaust of harmful nitrogen oxides by combining them with urea to form ammonia. Despite these solutions, the exhaust of carbon dioxide, the largest component of exhaust is not reduced.

The mechanical compression and storage of gasses coming from the exhaust is not practical due to weight and cost factors. In addition, a buildup of back pressure from an exhaust is generally known to stall the combustion process in an engine. In addition, the buildup of pressure can cause leaks within the cabin of the vehicle which can cause suffocation to vehicle passengers.

### SUMMARY

A system and method for the collection of motor vehicle combustion engine exhaust fumes incorporating an active control and sensor system is disclosed. The system and method are capable of detecting the placement of road installed exhaust collection tubing and ports, and moving an exhaust tube to the collection tubing. The tubing system may be installed under or on top of roads, within road barriers, as guard railing, or in other locations along roadways.

In exemplary embodiments, a robotic exhaust system includes: flexible tubing configured to connect to a tail pipe at a first end and to connect to an exhaust collection tubing interface at a second end; a motor configured to move the flexible tubing; a sensor configured to detect a marker in the road, wherein the marker provides information indicating a position of the exhaust collection tubing interface; and a controller configured to move the second end of the flexible tubing to the position of the exhaust collection tubing interface.

In exemplary embodiments, a system to collect exhaust gas from a moving vehicle includes: an exhaust collection tubing interface connected to a collection tubing and disposed adjacent a road; a robotic exhaust system comprising flexible tubing configured to connect to a tail pipe at a first end and to connect to the exhaust collection tubing interface at a second end; and a controller configured to move the second end of the flexible tubing to the position of the exhaust collection tubing interface.

It is to be understood that both the foregoing general description and the following detailed description are exemplary and explanatory and are intended to provide further explanation of the invention as claimed.

### BRIEF DESCRIPTION OF THE FIGURES

The accompanying drawings, which are included to provide a further understanding of the invention and are incorporated in and constitute a part of this specification, illustrate embodiments of the invention, and together with the description serve to explain the principles of the invention.

FIG. 1A illustrates an isometric view of a Robotic Exhaust Positioner (REP) attached or affixed to a vehicle for transferring exhaust to a road embedded collection tubing according to exemplary embodiments.

FIG. 1B illustrates a close up view of the REP and a motion control system according to exemplary embodiments.

FIG. 2A illustrates an isometric view of a vehicle with two REPs and a tubing collection system integrated within a road side barrier according to exemplary embodiments.

FIG. 2B illustrates an isometric view of a vehicle with a top mounted exhaust and top mounted REP (such as a tractor trailer) with collection pipes located or disposed higher than or above a height of the vehicle and vehicle exhaust according to exemplary embodiments.

FIG. 3 illustrates a cross section of a collection pipe, an interface between the REP and the collection tubing according to exemplary embodiments.

FIG. 4 is a flow chart of a method for collecting vehicle exhaust according to exemplary embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DESCRIPTION OF EMBODIMENTS

Exemplary embodiments will now be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. Various changes, modifications, and equivalents of the systems, apparatuses, and/or methods described herein will likely suggest themselves to those of ordinary skill in the art. Elements, features, and structures are denoted by the same reference numerals throughout the drawings and the detailed description, and the size and proportions of some elements may be exaggerated in the drawings for clarity and convenience.

Additional features of the invention will be set forth in the description which follows, and in part will be apparent from the description, or may be learned by practice of the invention.

A system and method for the collection of motor vehicle combustion engine exhaust fumes incorporating an active control and sensor system is disclosed. The system and method are capable of detecting the placement of road installed exhaust collection tubing and ports, and moving an exhaust tube to the collection tubing. The tubing system may be installed under or on top of roads, within road barriers, as guard railing, or in other locations along roadways.

The tubes may be equipped with valving including one way valving. The tubes may be able to interface in a continuous manner as a vehicle is moving.

The exhaust collected by the tubing system may be disposed or deposited within an air stream of pumped air. The exhaust may be pumped to a collection system.

The exhaust may be separated to collect waste products from exhaust, such as, heat energy, sound energy, exhaust gasses, water, and particulate matter.

The system for the collection of motor vehicle combustion engine exhaust fumes may be integrated in cities and large highway systems. In exemplary embodiments, the system for the collection of motor vehicle combustion engine exhaust fumes may allow for a vehicle to run independently, and may easily disassociate from the collection system.

In exemplary embodiments, the system enables the collection of vehicle emissions. The system allows for the collection of exhaust from vehicles. The collection of exhaust can be conveyed for centralized separation of particulate matter, carbon dioxide, nitrogen oxides, volatile organic compounds, hydrocarbons, and water.

In exemplary embodiments, the system enables collecting wasted heat and sound energy. The collected wasted heat and sound energy may be recoverable from the exhaust systems.

In exemplary embodiments, the system enables adapting to a wide range of vehicles, driving patterns, and roads.

In exemplary embodiments, the system creates little or no back pressure applied to the combustion process at the tail pipe. In other words, the vehicle exhaust exits the tail pipe of the vehicle into a pressure volume where the pressure is equal to or less than 1 atmosphere, equal to or less than 2 atmospheres, or equal to or less than 5 atmospheres.

In exemplary embodiments, the collection system may be tamper and vandalism resistant. In exemplary embodiments, the collection system may be as suitable for warm and cold climates, and with various types and levels of precipitation. In exemplary embodiments, the collection system be easily automatable and require little or no human interface.

In exemplary embodiments, the collection system may be easily turned off and/or de-coupled from the tubing system, when the vehicle is travelling through an area where the tubing system is not available, for example, in rural areas.

In exemplary embodiments, there is describe a coupled robotic exhaust pipe (REP) as well a system of tubing able to accept, collect and convey the exhaust from the REP. The REP may include flexible tubing, motors, sensors, and valving. The REP may be attached or connected to the motor vehicle at the tail pipe. The REP may be powered by an electric connection to the external tubing system. The REP may be powered by the vehicle's power system or by captured energy from the environment or exhaust waste. The REP may include sensors capable of detecting markers or electronic signals in the roads, road structure, or the collection tubing. The REP may dynamically move to couple with the collection tubing and to adjust for the position of the collection tubing as the vehicle moves.

In exemplary embodiments, the collection tubing system may be pressurized to create a flow of gas able to transport the collected exhaust away from a vehicle's tail pipe. The collection tubing system may be pressurized in an automated manner to maintain a proper flow. The interface of the REP and the collection tubing may include a passive or a dynamic one way valve system. The tubing system may use venturi air inlets to form a suction to collect exhaust gas from the REP as the vehicle travels in a continuous or intermittent manner. A venture air inlet may include a short tube with a tapering constriction in the middle that causes an increase in the velocity of flow of a fluid and a corresponding decrease in fluid pressure and that is used for creating a suction. The tubing system may be integrated within roadway structures, such as, the road, the underlayment, side barriers or railings, or simply exposed adjacent above, on or besides the road.

In exemplary embodiments, electronic communication between the REP and the collection tubing can be provided to monitor and devise an efficient collection methodology. In exemplary embodiments, the system can be connected, via the collection tubing, to a gas and/or particulate separation station for enabling the collection and in some cases compression of exhaust gases for transport. The exhaust gases can be compressed to form liquids.

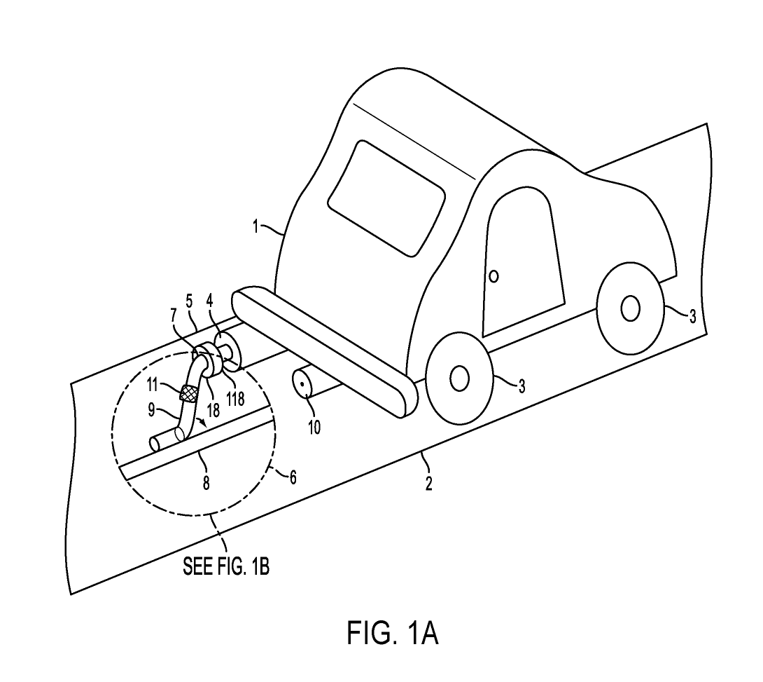

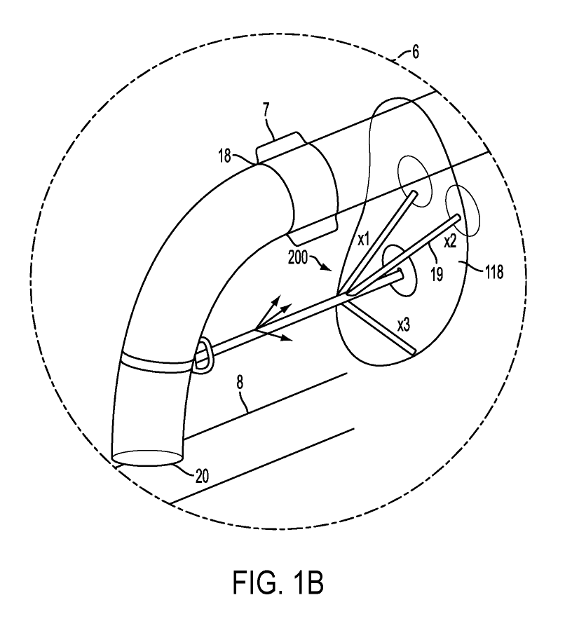

FIG. 1A illustrates an isometric view of a Robotic Exhaust Positioner (REP) attached or affixed to a vehicle for transferring exhaust to a road embedded collection tubing according to exemplary embodiments. FIG. 1B illustrates a close up view of the REP and a motion control system according to exemplary embodiments.

In FIG. 1A, a vehicle 1 travelling on a road 2 on a set of tires 3 with a tail pipe 4 may include a Robotic Emission Positioner (REP) 5. The REP 5 is further detailed with respect to FIG. 1B below. The REP may form a dynamically moving exhaust tube that can interface with an exhaust collection tube. The REP 5 is connected, attached or affixed to the tail pipe 7 near a tail pipe outlet 18. The REP 5 can include a motor system 118 for moving a flexible joint and tubing 11 in order to position an extension 9 of the REP 5 at an interface 20 of collection tube 8. The motor system 118 can include a servo or stepper motor. The motor system 118 may dynamically move extenders 19. The motor system 118 can move the extension 9 based on commands from a control system, where the control system receives input from sensors 200 embedded in the REP 5. In exemplary embodiments, the control system may receive input by on sensing the road 10.

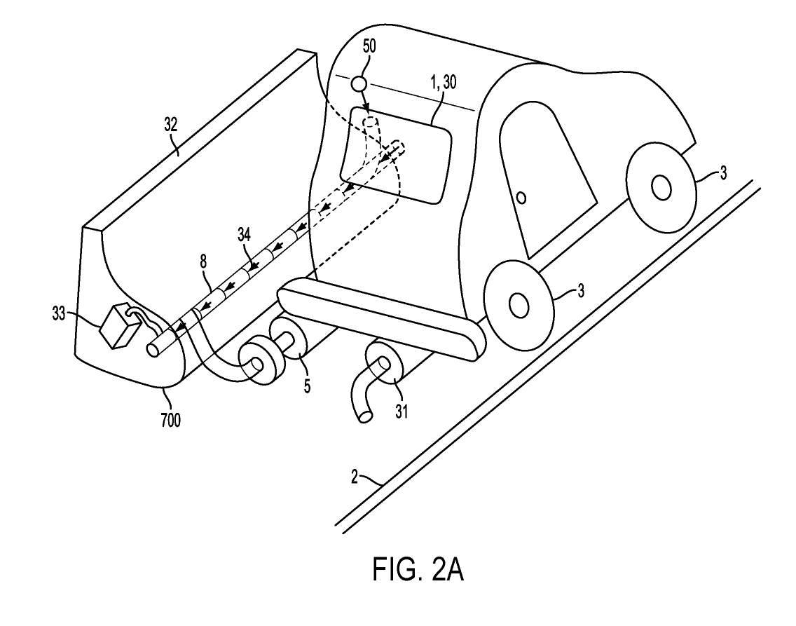

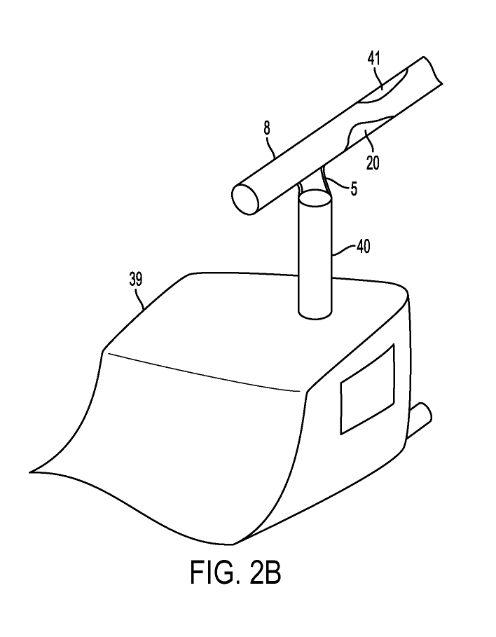

FIG. 2A illustrates an isometric view of a vehicle with two REPs and a tubing collection system integrated within a road side barrier according to exemplary embodiments.

In FIG. 2A, a vehicle 1, 30 is disposed to travel on a road 2 on a set of tires 3 fitted with an REP 5 as well as a secondary REP 31. The REP 5 interfaces with a collection tube 8 located or disposed within or along a road side wall 32. The road side wall 32 may be formed from materials such as concrete or steel. A pump 50 in the collection tubing system may be adjusted by a controller 33. The pump 40 may force air down or through the collection tube 8 past one or more one way valves 34. A section 700 forming the side wall 32 may fit additional road side sections (not shown) in a modular fashion so as to form a chain of sections to collect exhaust from a vehicle. Multiple vehicles can connect, attach or be affixed to the collection tubing system at the same time.

FIG. 2B illustrates an isometric view of a vehicle with a top mounted exhaust and top mounted REP (such as a tractor trailer) with collection pipes located or disposed higher than or above a height of the vehicle and vehicle exhaust according to exemplary embodiments.

In FIG. 2B, a large vehicle, such as, a tractor trailer 91, may include a vertically oriented tail pipe outlet 50 connected to a REP 5. The REP 5 may move to dynamically position itself and mate or couple with the collection tube 8 at interface 20. To ameliorate environmental conditions, such as, snow and ice 41, the collection tube 8 may be disposed to protect the interface 20, so that exposure to the elements is minimized for the interface 20.

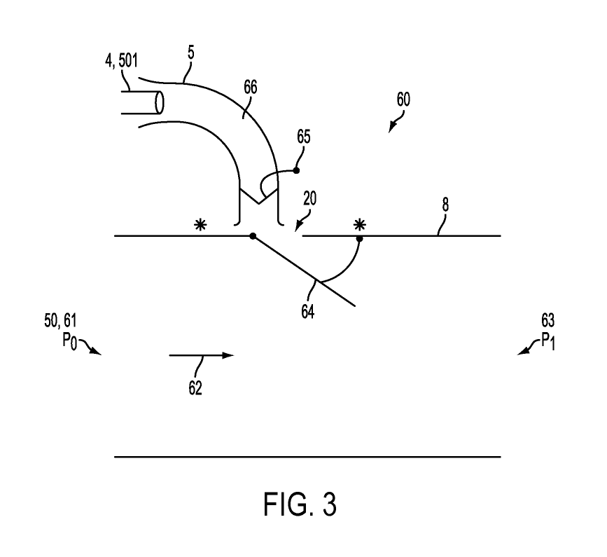

FIG. 3 illustrates a cross section of a collection pipe, an interface between the REP and the collection tubing according to exemplary embodiments.

In FIG. 3, a cross sectional view of the REP 5, the collection tube 8 and an interface system 60 is illustrated. Exhaust tail pipe 4,501 may emit exhaust 66 through one way valves 65. Exhaust tail pipe 4,501 may connect, couple or attach at interface 20 with the collection tube 8. The physical connection may be spaced by a gap, or may be a solid connection or flexible connection, such as, an air bladder, a bellows, or the like, so as to create a seal between the REP 5 and the collection tube 8. An air flow 62 may be created within the collection tube 8 by pump 50. The air flow 62 may form a pressure 61 (P₀) and exit pressure 63 (P₁). The pressure 61 (P₀) and exit pressure 63 (P₁) may be adjusted to optimize the collection or vacuum pressure required to pull, extract, or outflow exhaust from a tail pipe of a vehicle. The one-way valve 64 may be actuated mechanically or electromechanically. For example, a mechanical actuation force may include the exhaust generating an exhaust pressure at the one-way value and the exhaust pressure pushing one a one-way flap, a door or the like at the outlet of 5 to dispose the exhaust into the collection tube 8.

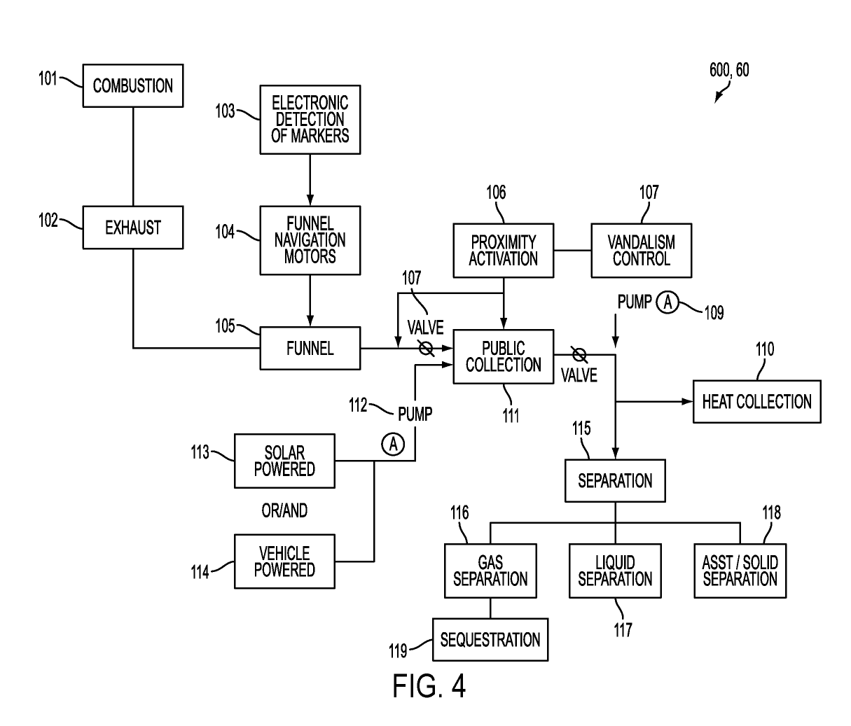

FIG. 4 is a flow chart of a method for collecting vehicle exhaust according to exemplary embodiments.

FIG. 4 illustrates a process or method 600 for collecting exhaust from the collection and interface system 60 commencing with an internal combustion engine 101 in operation 101 delivering an exhaust in operation 102. The exhaust may be delivered to a funneling device, such as, a robotic exhaust positioner (REP). in exemplary embodiments, the REP is getting input or control from electronic detection of markers at operation 103. In exemplary embodiments, the REP may control or drive motors so as to position the exhaust at the point of collecting publicly 111 in operation 104. In exemplary embodiments, the REP may activate when a proximity to a collection and interface system 60 is detected in operation 106. The proximity activation may occur along with initiating or activating valving procedures in operation 107. The proximity activation may occur along with initiating or activating a pump driving protocol 112 and 109. In exemplary embodiments, a vandalism control may shut the system down in operation 107 so as to prevent the contamination of the collection and interface system 60.

In exemplary embodiments, operation 113 may provide for collecting solar or renewable energy or heat collection from heat collector 110. The energy may be used using it to drive the electronics or mechanics of the REP in operation 114. In exemplary embodiments, the energy for any of the aforementioned collection processes of 600 (for example 111) may be provided by other power sources, such as, vehicle power. The process of further separating the collected exhaust 115 may include using gas separation 116, carbon dioxide sequestration 119, liquid separation and storage 117, dust and other solid particulate separation 118 (through for example filtering), or the like.

The examples presented herein are intended to illustrate potential and specific implementations. It can be appreciated that the examples are intended primarily for purposes of illustration for those skilled in the art. The diagrams depicted herein are provided by way of example. There can be variations to these diagrams or the operations described herein without departing from the spirit of the invention. For instance, in certain cases, method steps or operations can be performed in differing order, or operations can be added, deleted or modified.

What is claimed is:

1. A robotic exhaust system to connect to a vehicle, the robotic exhaust system comprising:
flexible tubing configured to connect to a tail pipe at a first end and to connect to an exhaust collection tubing interface at a second end;
a motor configured to move the flexible tubing;
a sensor configured to detect a marker in the road, wherein the marker provides information indicating a position of the exhaust collection tubing interface; and
a controller configured to move the second end of the flexible tubing to the position of the exhaust collection tubing interface.

2. The robotic exhaust system of claim 1, further comprising a one-way valve disposed between the first end and the second end of the flexible tubing, wherein the one-way valve is configured to allow the exhaust to flow from the first end to the second end of the flexible tubing.

3. The robotic exhaust system of claim 1, further comprising a flexible connection disposed on the second end of the flexible tubing and configured to connect the second end of the flexible tubing to the exhaust collection tubing interface.

4. The robotic exhaust system of claim 1, wherein the second end of the flexible tubing is configured to maintain an air gap, wherein the air gap is configured to connect the second end of the flexible tubing to the exhaust collection tubing interface.

5. The robotic exhaust system of claim 1, further comprising a blower disposed between the first end and the second end of the flexible tubing, wherein the blower is configured to assist the exhaust flow from the first end to the second end of the flexible tubing.

6. A system to collect exhaust gas from a moving vehicle, the system comprising:
an exhaust collection tubing interface connected to a collection tubing and disposed adjacent a road;
a robotic exhaust system comprising flexible tubing configured to connect to a tail pipe at a first end and to connect to the exhaust collection tubing interface at a second end; and
a controller configured to move the second end of the flexible tubing to the position of the exhaust collection tubing interface.

7. The system of claim 6, further comprising a motor configured to move the second end of the flexible tubing.

8. The system of claim 6, further comprising a sensor configured to detect a marker in the road, wherein the marker provides information indicating the position of the exhaust collection tubing interface.

9. The system of claim 6, further comprising a one-way valve disposed between the first end of the flexible piping and the collection tubing, wherein the one-way valve is configured to allow the exhaust to flow from the first end of the flexible tubing to the collection tubing.

10. The system of claim 6, further comprising a flexible connection configured to connect the second end of the flexible tubing to the exhaust collection tubing interface.

11. The system of claim 6, wherein the second end of the flexible tubing is configured to maintain an air gap, wherein the air gap is configured to connect the second end of the flexible tubing to the exhaust collection tubing interface.

12. The system of claim 11, wherein the exhaust collection tubing interface comprises a venturi air inlet.

13. The system of claim 6, further comprising a pump configured to create an airflow in the collection tubing.

14. The system of claim 6, further comprising an exhaust separation system configured to separate one or more of carbon monoxide, nitrous oxide, volatile organic compounds, or particulates from the exhaust.
